(19) United States
(12) Patent Application Publication
(10) Pub. No.: US 2017/0290319 A1
(43) Pub. Date: Oct. 12, 2017

(54) LARGE VOLUME GRAVID TRAPS

(71) Applicant: The Regents of the University of California, Oakland, CA (US)

(72) Inventors: William E. Walton, Riverside, CA (US); David A. Popko, Riverside, CA (US)

(21) Appl. No.: 15/485,406

(22) Filed: Apr. 12, 2017

Related U.S. Application Data
(60) Provisional application No. 62/321,513, filed on Apr. 12, 2016.

(51) Int. Cl. A01M 1/08; A01M 1/02; A01M 1/10

(52) U.S. Cl. CPC A01M 1/08; A01M 1/106; A01M 1/02

(57) ABSTRACT

The disclosure provides for large volume gravid traps, and uses thereof.

### CROSS REFERENCE TO RELATED APPLICATIONS

This application claims priority under 35 U.S.C. §119 to U.S. Provisional Application Ser. No. 62/321,513, filed on Apr. 12, 2016, the disclosure of which is incorporated herein by reference in its entirety.

### FIELD OF THE INVENTION

The disclosure provides for large volume gravid traps, and uses thereof.

### BACKGROUND

Gravid mosquito sampling is a key component of vector surveillance that can enhance pathogen detection rates and improve the precision of predictive models used to guide vector control strategies. Gravid adult mosquitoes that have taken a bloodmeal are more likely to harbor blood-borne pathogens than non-gravid mosquitoes collected by other methods such as light traps and carbon dioxide-baited suction traps.

### SUMMARY

This disclosure provides for large volume gravid traps (LV-gravid), and the use of the traps to capture flying insects, such as mosquitos or sand flies. In a particular embodiment, the disclosure provides for a large volume gravid trap (LV-gravid trap) comprising: a container capable of holding at least 25 liters of liquid; one or more suction vacuum traps; wherein the one or more suction vacuum traps are either: (1) inserted through an opening of the side of container so that the lower portion of the suction vacuum trap projects into the inside of the container; or (2) attached to the top of the container by use of an attachment means or by use of supports and suction trap holders. In a further embodiment, the one or more suction traps are selected from CDC light gravid suction traps, Frommer Updraft gravid suction traps, and Reiter Cummings traps. In a particular embodiment, the one or more suction traps are CDC light gravid suction traps. In another embodiment, the LV-gravid trap disclosed herein comprises a container capable of holding 120 liters of liquid. In a further embodiment, the container is a 40- to 60-gallon plastic trashcan. In yet a further embodiment, the container is black, dark brown, or dark grey in color. In another embodiment, the container comprises an opening at the base of the container to allow for drainage of liquid from the container, wherein the opening may be plugged or closed to prevent unwanted drainage of the liquid from the container.

In a certain embodiment, the disclosure provides for a LV-gravid trap disclosed herein comprises side mounted suction traps, wherein the one or more suction traps are inserted at an angle from 40° to 70° through an opening of the side of container so that the lower portion of the suction vacuum trap projects into the inside of the container. In a further embodiment, the suction trap is inserted at a 60° angle through the opening of the side of the container, and wherein the opening is located about halfway down the side of the container.

In a particular embodiment, the disclosure also provides for a LV-gravid trap disclosed herein which comprises supports for supporting top mounted suction traps, wherein the supports are of a sufficient length to overlay or be attached to two opposing sides of the container. In a further embodiment, the supports overlay two opposing sides of the container and further comprise notches or grooves that are dimensioned so that the top surface of the opposing sides of the container can slideably fit into the notches or grooves. In yet a further embodiment, the notches or grooves are curved so as to fit the top surface of the opposing sides of a cylindrical container. In another embodiment, the LV-gravid trap comprises suction trap holders for top mounted suction traps, wherein the suction trap holders fit around the lower portion of the one or more suction traps and are capable of being joined together using a fastening means. In yet another embodiment, the suction trap holders comprise holes that can accommodate bolts, wherein the bolts are used to join the suction trap holders together.

In a certain embodiment, the disclosure further provides for a LV-gravid trap disclosed herein which comprises a container that contains at least 35 liters of an infusion comprising fermented plant matter. In yet a further embodiment, the container comprises from 35 liters to 100 liters of infusion comprising fermented plant matter.

### DESCRIPTION OF DRAWINGS

FIG. 1 provides a close-up view of various components that can make up a large-volume gravid trap (LV-gravid trap) of the disclosure.

FIG. 2 provides two views of an exemplary LV-gravid trap of the disclosure (left panel). Also shown, are size dimensions for an exemplary container that can be used with the LV-gravid trap disclosed herein (middle panel); and size dimensions for exemplary supports and suction trap holders that can be used with the LV-gravid trap disclosed herein (right panel).

FIG. 3A-D presents embodiments of LV-gravid trap as disclosed herein: (A) large plastic gravid trap with top-mounted suction traps; (B) close up view of a LV-gravid with top-mounted suction traps; (C) view of a side-mounted suction trap in a large plastic gravid trap. (D) shows actual embodiments of LV-gravid traps of the disclosure.

FIG. 4 demonstrates the abundance (mean±SE) of adult female Culex mosquitoes in small-volume and LV-gravid traps, year 1-year 3. Dotted lines indicate where timeline is condensed for illustration purposes.

FIG. 5 demonstrates the abundance (mean±SE) of female mosquitoes (light gray fill) and egg rafts (dark gray fill) per sample night among years, infusion volumes, and gravid trap designs. Sm=Small-volume gravid traps. Lg=LV-gravid plastic traps with top-mounted suction traps. Lg-S=LV-gravid plastic traps with side-mounted suction traps. FG=LV-gravid fiberglass traps. Letters indicate significant differences of gravid mosquito collections: ^{ABC}KW-ANOVA P<0.05 and ^{abc}Tukey's HSD P<0.05.

FIG. 6 shows the percentages (mean±SE) of gravid (light bars), non-gravid (gray bars), and unknown fecundity (dark bars) for female mosquitoes in gravid trap collections from year 2 and year 3. Gravid numbers included females with visible eggs or blood meals. Sm=small-volume gravid traps. Lg=LV-gravid plastic traps with top-mounted suction traps. Lg-S=LV-gravid plastic traps with side-mounted suction traps. FG=LV-gravid fiberglass traps.

FIG. 7 demonstrates the abundance (mean±SD) of egg rafts (dark gray fill) and/or female mosquitoes (light gray fill) during autumn year 3 when suction traps were absent (left panel), were present and turned off (middle panel), and were turned on (right panel) within different gravid traps and infusion volumes. Sm=small-volume gravid trap. Lg=large-volume plastic gravid trap. FG=Fiberglass gravid trap. Letters indicate significant differences of gravid mosquito collections: ^{abc}(egg rafts) and ^{ab}(adults) Tukey's HSD P<0.05.

FIG. 8 presents mosquito numbers (mean±SE) that were caught in the gravid traps (6-L volume) of the disclosure at UC Riverside, Valley Sanitary District, and Prado wetlands in Southern California. Manure-infused baits were compared to controls (pond water) in multiple overnight experiments (indicated by dotted partitions). QnQ=Cx. quinquefasciatus. ERY=Cx. erythrothorax. TAR=Cx. tarsalis.

FIG. 9 presents a comparison of mosquito abundance (mean±SD) and species composition in large- and small-volume gravid traps of the disclosure with varied infusion ages at UC Riverside. TARS=Culex tarsalis, QUINQ=Culex quinquefasciatus, and CULEX=unidentified Culex spp. mosquitoes.

FIG. 10 demonstrates the average abundance of female adult mosquitoes caught in large and small volume gravid traps of the disclosure from Coachella Valley locations.

FIG. 11 presents a Table showing the numbers of adult female mosquitoes (mean±SD) collected in gravid traps and egg rafts (mean±SD) found floating in infusion containers at UC Riverside.

### DETAILED DESCRIPTION

As used herein and in the appended claims, the singular forms “a,” “an,” and “the” include plural referents unless the context clearly dictates otherwise. Thus, for example, reference to “a gravid trap” includes a plurality of such traps and reference to “the suction trap” includes reference to one or more suction traps known to those skilled in the art, and so forth.

Also, the use of “or” means “and/or” unless stated otherwise. Similarly, “comprise,” “comprises,” “comprising” “include,” “includes,” and “including,” and “have,” “haves,” and “having,” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of.”

Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices and materials are described herein.

All publications mentioned throughout the disclosure are incorporated herein by reference in full for the purpose of describing and disclosing the methodologies, which are described in the publications, which might be used in connection with the description herein. Moreover, with respect to similar or identical terms found in the incorporated references and terms expressly defined in this disclosure, the term definitions provided in this disclosure will control in all respects.

Gravid traps used for Culex spp. surveillance have included a variety of trap designs and oviposition attractants. CDC gravid traps and traps of similar design can effectively collect mosquitoes in the Culex pipiens L./Culex quinquefasciatus Say species group that are important vectors of arboviruses in urban environments; but, standard gravid traps containing <5 liters of hay/grass infusion provide variable gravid female interception rates and unintended egg raft production due to interactions among infusion volume, trap surface area, and container color characteristics.

Small-capacity gravid traps often fail to attract the diverse range of mosquito species capable of transmitting arboviruses. Despite different baiting strategies, important vectors such Culex tarsalis Coquillett are rarely collected using standard gravid trap methodologies even when substantial populations of host-seeking individuals (and presumably gravid individuals) are present. Mosquito oviposition is modulated by a variety of physical as well as chemical factors. Culex tarsalis is associated with comparatively large, structurally complex habitats and responds to different habitat cues than does Cx. quinquefasciatus whose larvae occur often in comparatively structurally simple and organically enriched environments. Whereas both mosquito species colonized 1−m² microcosms, larvae of each species were associated with different water quality and vegetation regimes.

The disclosure provides for large volume gravid traps (LV-gravid traps). The LV-gravid traps disclosed herein collected on average five-fold more adult female Culex mosquitoes compared to standard CDC gravid traps. Experimental and environmental factors contributed to differences of trap performance between large-volume and small-volume gravid traps that ranged from zero to thirty-fold. Changing the container type, infusion volume and concentration were significantly associated with changes in the size and species composition of mosquito collections. Suction trap number and mounting style, and infusion age contributed less to the observed differences in mosquito collections between gravid trap designs. Accordingly, LV-gravid traps disclosed herein offer a promising alternative to the small-volume CDC gravid traps used traditionally for mosquito-borne disease surveillance. Unexpectedly the LV-gravid traps disclosed herein collect more gravid mosquitoes and, at times during the annual activity period of Culex adults, collect significant numbers of principal arborvirus vectors such as Cx. tarsalis, especially during the spring when mosquito populations and arbovirus populations are increasing annually. One might expect that the change is size would affect the number of insects captured, however, the size of the trap also surprisingly changed the species captured. LV-gravid traps disclosed herein can be comprised of relatively inexpensive components (e.g., plastic trashcans).

Among six large-volume trap combinations tested, two black-plastic container designs, each with a different suction trap mounting style and infusion volume, were most effective at gravid mosquito monitoring. Top-mounted dual suction traps and 100 liters of infusion provided the greatest yields for the combined abundance of all mosquito species as well as gravid Cx. tarsalis and Cx. stigmatosoma. This gravid trap configuration was the most effective at collecting mosquitoes across an order-of-magnitude increase in mosquito abundance between year 2 and year 3 that coincided with increased bulrush density in adjacent wetlands and across seasons. The differences in the numbers and species of mosquitoes collected by large-volume gravid traps and CDC gravid traps were more pronounced in the spring compared to summer and autumn. This evidence suggests that the LV-gravid traps of the disclosure filled with infusion volumes >6 liters have the potential to enhance gravid mosquito collection and the detection of infected mosquitoes early in the annual activity period of vector mosquitoes. Early-season detections of arbovirus-infected mosquitoes can aid in the prediction of late season severity of diseases such as those caused by West Nile virus.

In a subset of experiments, the LV-gravid traps disclosed herein comprising side-mounted suction traps and 35 liters of infusion exhibited equal trapping efficiency to the LV-gravid traps disclosed herein comprising top-mounted suction traps. Whereas the numbers of female mosquitoes collected were directly related to infusion volume in large-volume, black-plastic gravid traps with top-mounted suction traps, the distance between the infusion surface and the bottom of the suction trap (about 10 cm) was similar for the top-mounted suction traps above 100 liters of infusion and side-mounted suction traps above 35 liters of infusion. Disruption of this suction force was likely magnified across the larger suction-trap-to-infusion-surface distances in gravid traps with top-mounted suction traps and comparatively small infusion volumes (<35 liters). Reduced infusion volume reduced gravid mosquito abundance and increased the proportion of non-gravid females in suction trap collections, as well as increased egg raft numbers, compared to trap designs with large infusion volumes. Moreover, the enclosed nature of the side-mounted design probably created air flow fields to boost adult interception rates and reduce egg-lay relative to the more exposed top-mounted design.

LV-gravid dark-plastic traps disclosed herein with intermediate levels of organic infusion may have also created a humid microenvironment within the trap that was favorable to mosquito activity as indicated by an order-of-magnitude increase in egg raft numbers in containers (suction traps absent) with 35 liters of infusion compared to traps with 100 liters of infusion. However, egg raft numbers in gravid traps with top-mounted non-functional suction traps and 35 or 100 liters of infusion were similar. This outcome was surprising given the large area available for mosquito entry and Culex spp. mosquitoes are known to colonize habitats with structural barriers—e.g. wetlands with dense stands of emergent vegetation and underground storm drain systems. It is plausible the top-loaded trap rail-system may have disturbed mating interactions since males were half as abundant in functional top-mounted traps compared to side-mounted trap pairs; although it was unclear to what extent this would have impacted gravid females.

The headspace above side-mounted suction traps likely also served as a favorable microhabitat for mosquito resting and encouraged mosquito colonization. Wind speed was noticeably reduced inside large plastic containers with lower volumes and would have been expected to be a key determinant of collection efficiency mosquito suction traps. Local wind speeds averaged 1-2 m/s during dawn/dusk hours (autumn year 3, UC Riverside, station 44, California Irrigation Management Information System (CIMIS), Dept. of Water Resources, Sacramento, Calif.) when ovipositional activity was presumed to be greatest during the diurnal oviposition habit of Culex mosquitoes. The interior of the large-volume gravid trap also was a region of comparatively high humidity commonly preferred for resting adult mosquitoes and associated with increase survival and fecundity. One post-study measurement indicated that the 35-liter infusion formed a 20-cm tall zone of constant relative humidity 10% higher than that measured near the surface of 100-liter infusion at a constant temperature. A calm microenvironment may have further impacted the plume signal of trap baits and created an enriched zone of volatile chemical cues emitted during bait fermentation important in both long- and short-range mosquito oviposition behaviors.

The LV-gravid trap disclosed herein with side-mounted suction traps and 35 liters of infusion was particularly useful for vector control monitoring programs because it would be a more practical option than the gravid trap using top-mounted suction traps and 100 liters of infusion. The smaller infusion volume was easier and less expensive to store, transport, and manipulate than the larger infusion volumes. Side-facing suction traps were more secure than the top-mounted suction traps.

The number of suction traps per container was not associated with total mosquito numbers in collections, such that a mosquito catches by a single suction trap equaled that by two suction traps regardless of container type and mounting design. However, suction trap number was linked to the numbers of egg rafts on the infusion surface and the relative abundance of gravid versus non-gravid mosquitoes in collections from the large-volume gravid traps. For gravid traps with top-mounted suction traps and 100 liters of infusion, two suction traps decreased egg rafts and the proportion of non-gravid female mosquitoes in collections and conversely increased the proportion of gravid Cx. quinquefasciatus compared to one suction trap. Dual suction traps were probably more efficient at intercepting gravid mosquitoes before oviposition and are therefore recommended for top-mounted designs. Suction trap number however was not linked to differences among collections of gravid Cx. tarsalis and Cx. stigmatosoma and appeared to impact gravid mosquito collections by gravid traps with the side-mounted suction traps to a lesser or even opposite manner: the proportion of gravid Cx. quinquefasciatus increased in single suction trap setups.

To purposely target Cx. tarsalis, infusion concentration used for the tests was typically lower than the 4 g of organic matter/liter recommended for CDC-style traps; however, no evidence was obtained that less concentrated baits were more effective attractants and/or strong baits inhibited Cx. tarsalis collection. A possible consequence of using LC and LCI was to reduce the numbers of dirty-water species such as Cx. quinquefasciatus and Cx. stigmatosoma, which responded to infusion composition more readily than did Cx. tarsalis as evident in this and other studies. Interestingly, the large-volume gravid trap with the weakest bait (0.1 g/L) collected ten-fold more Cx. quinquefasciatus than CDC gravid traps with the strongest (4 g/L) infusion that was tested. This trend was consistent with the difference of gravid mosquito collections between large- and small-volume gravid traps and suggested infusion concentration played a relatively minor role among different gravid trap designs under field conditions.

Bait fermentation age was not a significant factor in the performance of fiberglass large-volume or small-volume gravid traps. This finding was unexpected considering addition of organic matter changed the abundance and species composition of Cx. quinquefasciatus, Cx. stigmatosoma and Cx. tarsalis in developmental sites over the course of several weeks. Transient peaks in oviposition of the aforementioned studies were in open-water systems with extensive top-down (e.g. consumption by larval mosquitoes) and/or bottom-up (e.g. dilution) regulation of microbial growth that could have altered the chemical signature of oviposition sites. A lack of a transition in mosquito abundance and/or species in the experiments may have been related to the predominately sealed, semi-transparent nature of the fiberglass containers. Dense algal mats thrived in the sunlight-exposed environment devoid of filter-feeding invertebrates such as mosquitoes. The proximity of different treatments in each replicate block of the experiment also may have interacted to reduce differences in the volatile signals related to bait age. Last, the overall low levels of mosquito populations during autumn of year 1 could have precluded the detection of bait age effects.

Color and water surface area were other variables that may have altered the effectiveness of the gravid traps to collect different mosquito species. Gravid Cx. quinquefasciatus are known to prefer dark-colored bait over light-colored bait in the laboratory and dark-colored habitat has been associated with increased mosquito numbers in field mesocosms. It has been reported a three-fold increase in Cx. quinquefasciatus adult abundance in dark-colored gravid traps with twice the surface area and volume than light-colored traps; however, other studies showed no change in Cx. quinquefasciatus adult numbers in traps with the same color and surface area that differed in volume two-fold. The color and two-fold difference in surface area between large-volume plastic and small-volume gravid traps were expected to increase the differences in gravid mosquito collections between designs; however, adult mosquito abundance (albeit with differences in the proportion of non-gravid females and egg raft numbers) was similar when bait volume was the same (6 liters) in both types of gravid traps. Also surprising was that light-colored fiberglass cylinders performed poorly compared to the maximum volume large plastic design despite a one-third greater volume and nearly 20% greater surface area.

The accompanying drawings, which are incorporated into and constitute a part of this specification, illustrate one or more, non-limiting, embodiments of the disclosure and, together with the detailed description, serve to explain the principles and implementations of a LG-gravid trap of the disclosure. Like reference symbols in the various drawings indicate like elements.

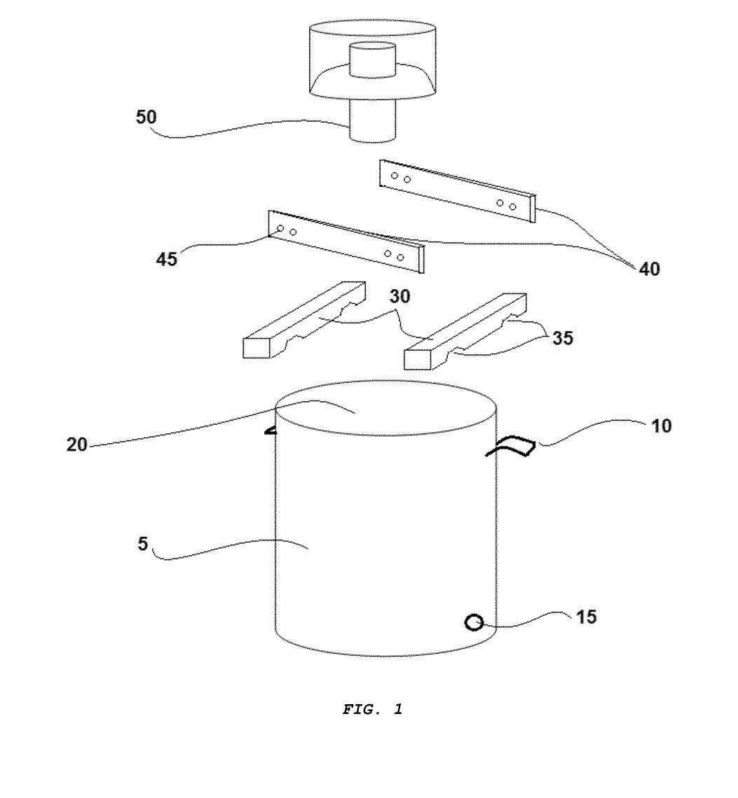

An overview of an exemplary LV-gravid trap of the disclosure is presented in FIG. 1. A container 5 is provided. Container 5 is suitably dimensioned to hold at least 20 L of liquid. In a particular embodiment, container 5 can hold at least 30 L, 35 L, 40 L, 45 L, 50 L, 60 L, 70 L, 80 L, 90 L, 100 L, 110 L, 120 L, 130 L, 140 L, 150 L, 160 L, 170 L, 180 L, 200 L, 250 L, 300 L, 400 L, up to 500 L, or a range between any two of the foregoing numbers, including fractional increments thereof. In a further embodiment, container 5 is made of material including, but not limited to, plastic, fiberglass, metal, concrete, and wood. In yet a further embodiment, container 5 can be comprised of an outer container which may or may not be water tight, and an internal membrane or liner made of a water tight material, such as rubber, or plastic. In another embodiment, container 5 may further comprise wheels at its base for ease of movement to various locations. In a further embodiment, container 5 may be any shape, including, but not limited to, cylindrical (as shown), and cuboid. In yet another embodiment, container 5 may further comprise one or more handles 10. Handles 10 may be located anywhere on the surface of container 5, including at the top of container 5 as shown. Container 5 comprises an internal volume 20 that can be filled with liquid. The internal surface of container 5 may be made of a different material compared to the rest of container 5. For example, container 5 can be made of wood or cement while internal surface 20 may comprise plastic or rubber (e.g., a lining). Container 5 may also comprise one or more openings of sufficient size so as to allow for the lower portion of suction trap 50 to be inserted through the opening above a liquid surface in volume 20. For convenience, container 5 may further comprise an opening 15 at the bottom of container 5 to allow for drainage of liquid. Opening 15 may be covered with a plug, connector, tap, or faucet, so as to cover or close the opening to prevent liquid draining out. The size of opening 15 can be of any size, but generally should be a size sufficient to allow for rapid or moderate drainage of liquid from container 5, but which can be easily covered, closed or plugged to prevent unwanted drainage of the liquid from container 5.

Also shown in FIG. 1 is support 30. Support 30 may optionally comprise notches 35. The notches 35 assist in placement and reducing movement of the supports on container 5. Support 30 should be of sufficient length to overlay or be attached to two opposing sides of container 5. In a particular embodiment, support 30 is of sufficient length to overlay or overhang two opposing sides of the top of container 5. In another embodiment, support 30 comprises notches or grooves 35 that are dimensioned so that the top surface of container 5 can slideably fit into notches or grooves 35. Notches or grooves 35 should be curved in order to slideably accommodate the tops surface of a cylindrical container 5. If container 5 is cuboid than notches or grooves 35 should be straight. Alternatively, internal surface of container 5 may comprise grooves that can slideably accommodate the ends of support 30. In such a case support 30 may lack notches or grooves 35. In other alternate embodiments, support 30 may be attached to two opposing sides of container 5 by way of an attachment means, such as use of screws, fasteners, clamps, hooks, and the like. In such a case support 30 may lack notches or grooves 35. Support 30 can be made of any material, and can have any shape. Examples of materials for support 30, include plastic, metal, and wood. Examples of shape for support 30, include rectangular cuboid, cylindrical rod shaped, or irregular shaped. In a certain embodiment, if two support 30 are used then the two support 30 should be spaced apart so as to allow passage of the lower portion of suction trap 50.

Also shown in FIG. 1, are suction trap holders 40. Suction trap holder 40 may further comprise one or more holes 45 that can be used with a fastener means, such as bolts, screws, rods, dowels, and the like. Alternatively, suction trap 50 may be attached directly to support 30 using an attachment or fastening means. As shown, suction trap holders 40 fit around the lower portion of suction trap 50 and are then joined together by multiple fastener means using holes 45. In a further embodiment, suction trap holders 40 lower surfaces rest on the top surface support 30. In yet a further embodiment, the LV-gravid trap of the disclosure comprises one or more suction trap 50. Examples of suction trap 50 include but are not limited to CDC light gravid suction trap (John W. Hock Company), Frommer Updraft gravid suction trap (John W. Hock Company), and Reiter Cummings trap (all commercially available traps).

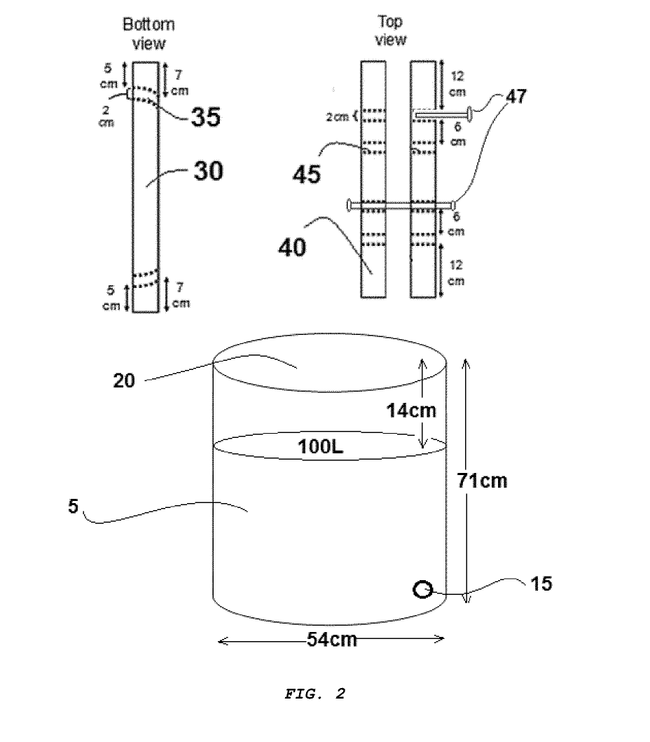

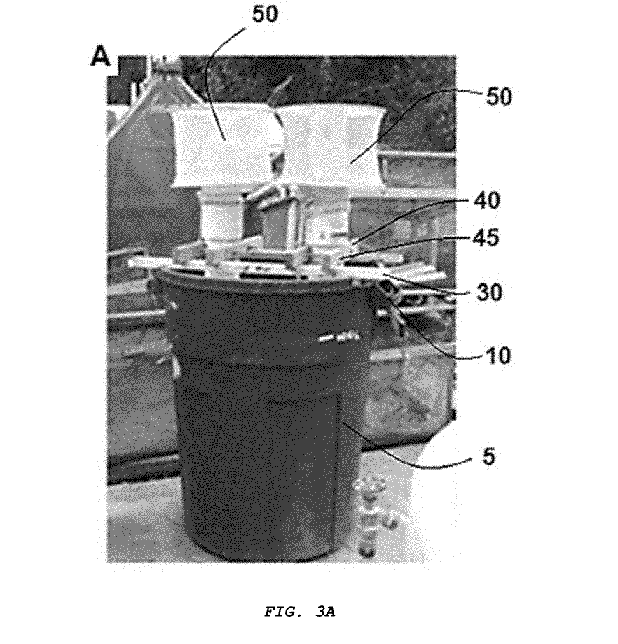

FIG. 2 provides additional embodiments of LV-gravid trap of the disclosure. As shown, container 5 is cylinder shapes and capable of holding at least 100 L of liquid. Container 5, in this exemplary embodiment, is depicted as being 85 cm in height and 54 cm in diameter. Also shown in FIG. 2 is opening 15. Opening 15, in this exemplary embodiment, is shown as being 1⅜ inches in diameter. Further, as indicated, a #7 stopper can be used to plug opening 15. Also depicted are exemplary embodiment of holder 30 and complementary pairs of suction holder 40. As shown, holder 30 comprises two grooves or notches 35. Furthermore, grooves 35 are depicted as being curved, and having a width of 2 cm. Suction holder 40 in the depicted embodiment, comprises four holes 45. As shown, holes 45 can have a width which can accommodate a fastening means, and are generally placed equal distant from the ends such that a pair of suction holder 40 members have aligned holes 45 that can allow fastener 47 to connect the two holders 40.

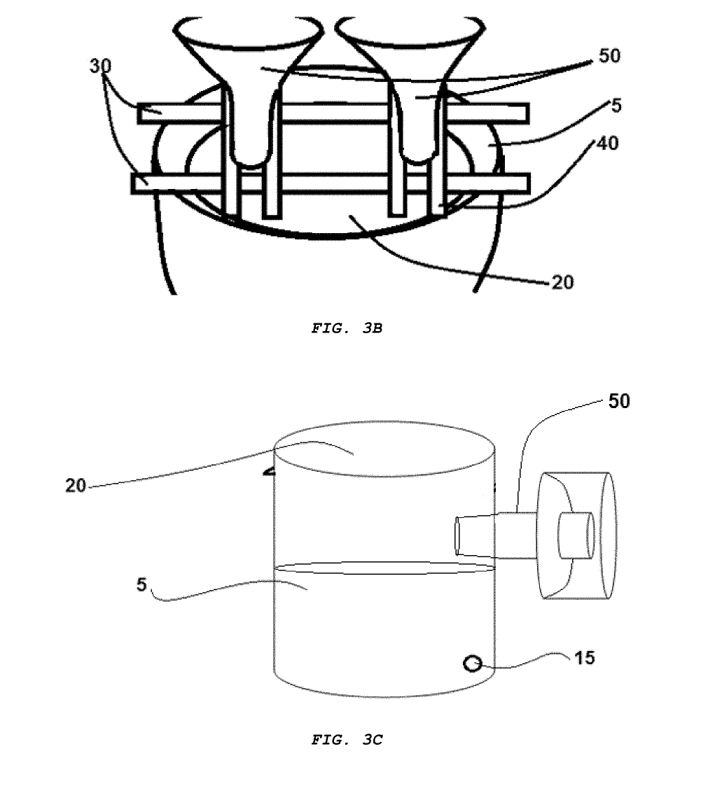

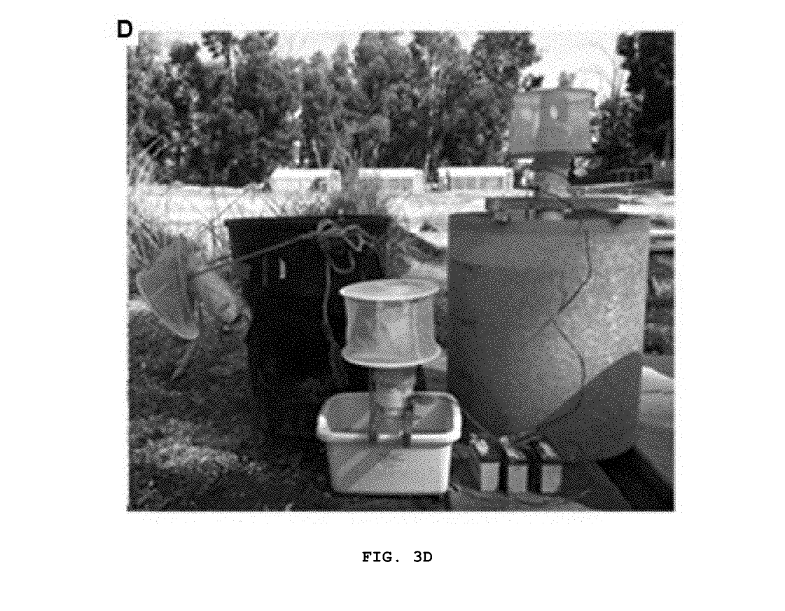

FIG. 3A provides a side view picture of an exemplary LV-gravid trap of the disclosure. As shown, two suction trap 50 are held in place using four fastened suction trap holder 40 which are overlaying two holder 30 which are affixed to the top of container 5 which comprises handles 10.

FIG. 3B, provides an exemplary embodiment showing a close up view of two suction trap 50 which are held in place using 4 suction trap holder 40 that are fastened together using bolts, which are sitting on top two holder 30 which are affixed or rest on the top of container 5 by use of curved grooves 35 (not depicted). The curved grooves 35 are slideably accommodating the top sides of cylindrical container 5. As shown, container 5 contains liquid 20.

FIG. 3C shows another exemplary LV-gravid trap of the disclosure. In this embodiment, LV-gravid trap of the disclosure is side mounted to container 5 wherein the lower portion of suction trap 50 can be inserted through an opening in container 5 and overhang liquid 20. In a further embodiment, suction trap 50 is orientated to have a certain angle in regards to the side of the container 5. In a particular embodiment, suction trap 50 is at angle of 40°, 45°, 50°, 55°, 60°, 65°, 70°, or a range of any two of the foregoing angles, including fractional increments thereof. In the case of a side mounted suction trap 50, the LV-gravid trap does not further comprise support 30 or suction trap holder 40.

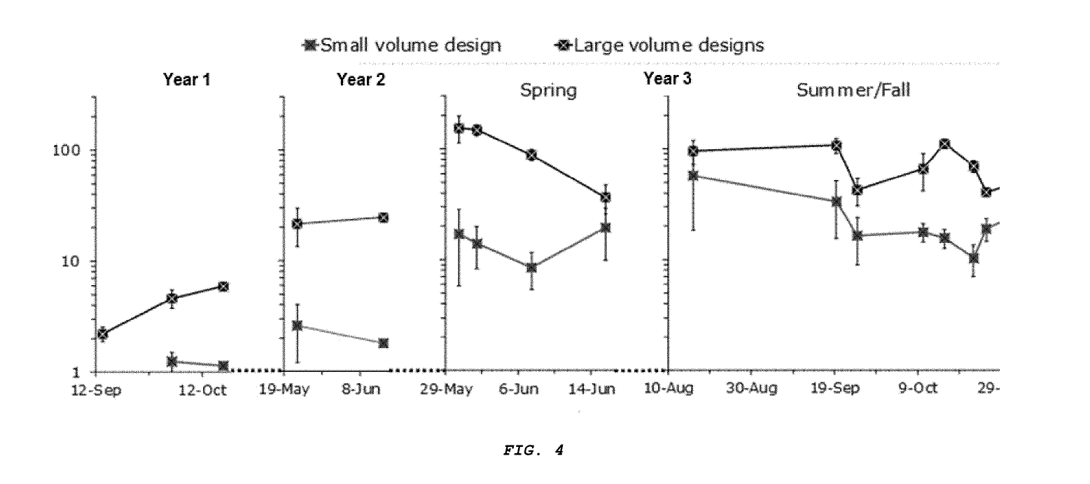

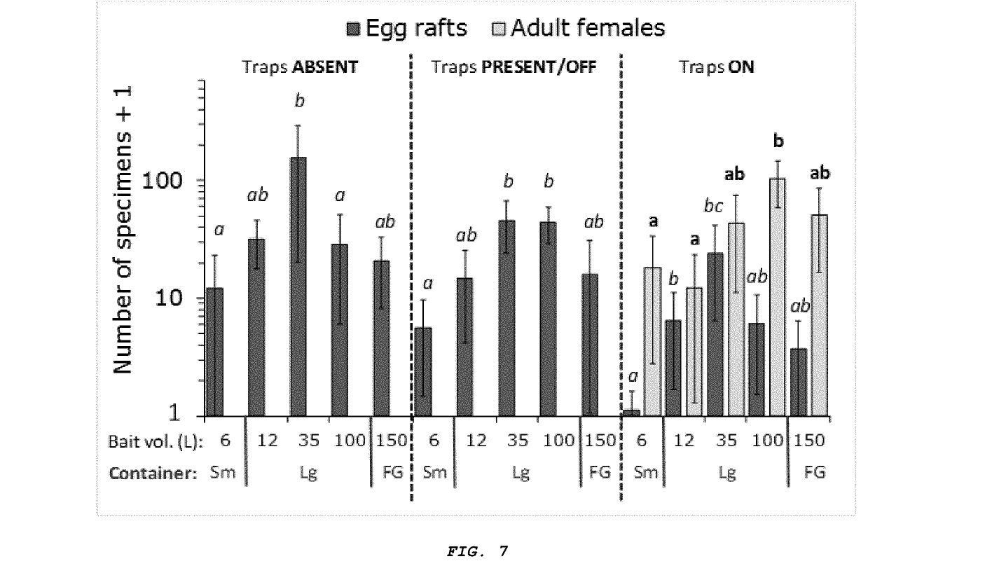

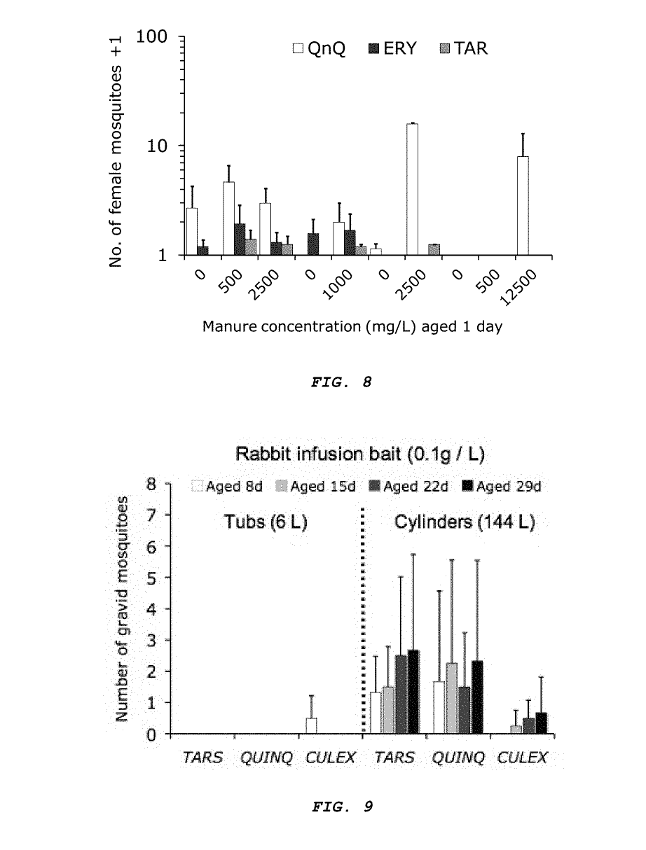

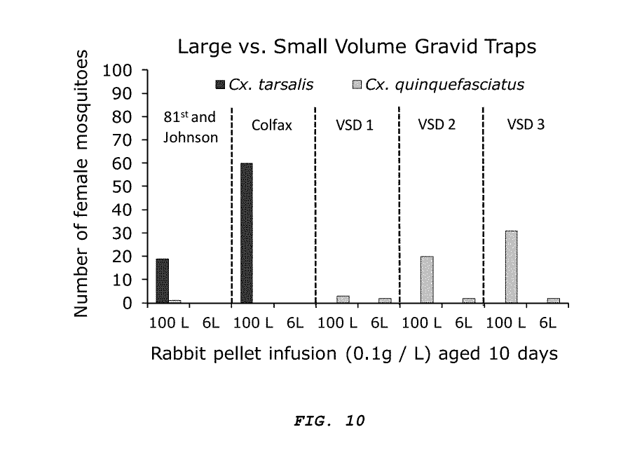

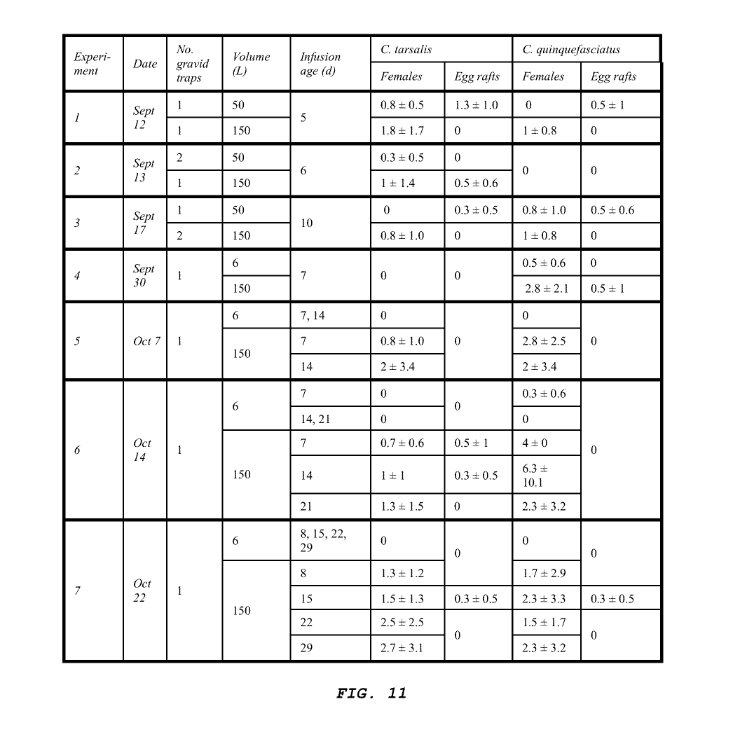

FIGS. 4-11 provide data showing that the LV-gravid trap was significantly better at catching gravid mosquitos than the commonly used low volume CDC gravid trap.

### Examples

Field Site:

LV-gravid traps of the disclosure were tested at the University of California at Riverside (UCR) Aquatic and Vector Control Research Facility. The study area was surrounded by eucalyptus trees and citrus groves. Traps were located in an open, sunlit area within the facility. Four 32-m² wetlands containing alkali bulrush [Schoenoplectus (=Scirpus) maritimus (L.) Lye] were adjacent to the study site.

Standard CDC Gravid Traps:

The CDC gravid trap (Model 1712, John W. Hock Company, Gainesville, Fla.; see FIG. 1D, bottom) containing 6 liters of oviposition infusion in a light-colored (beige) plastic dishpan (maximum volume=15 liters) was considered a small-volume design. The CDC gravid trap, or a modified version of the trap, is widely deployed in mosquito surveillance programs. A single suction trap was used with each gravid trap except during studies in spring of year 3 when two suction traps were placed over the basin holding the organic infusion.

Construction of LV-Gravid Traps.

Large-volume gravid traps were built using two types of containers (see FIG. 2A-B). Yellow, semi-transparent fiberglass drums (diameter=60 cm, height=100 cm) that held ≦225 liters of organic infusion were used during the first and third year of this study. A dark-colored, plastic garbage can (Rubbermaid, Fairlawn, Ohio; Roughneck®, diameter=56 cm, height=72 cm) with a maximum organic infusion volume of 121 liters was the second container type tested.

The number and orientation of suction traps on the large-volume gravid traps differed among the experiments. Either single or multiple (2 or 3) suction traps (height=44 cm, inner diameter=8 cm) with collection nets were used in the trials. When suction traps were oriented vertically above the infusion in the large-volume gravid traps, the wooden rails (length=40 cm) holding the suction trap were mounted on top of two wooden furring strips (1.9 cm×3.8 cm×61 cm) customized with shallow grooves to fit into the tops of the large-volume containers and placed 30 cm apart. When multiple suction traps were deployed on top of each large-volume gravid trap, they were placed equidistantly from each other along the length of the customized rails. In some experiments, infusion volume in the large gravid traps was reduced to 35 liters and suction traps were mounted at approximately 60° through container walls to maintain a distance of 10 cm between suction traps and the infusion surface (see FIG. 2). An additional suction trap mounting system composed of traps secured to wooden rails halfway down the insides of the large plastic containers was tested; however, the air flow (i.e., fan exhaust) within the gravid trap presumably caused this design to perform poorly and it will not be discussed further. Each fan motor was powered by a rechargeable 6-V battery and ran continuously overnight (average duration=18 h). Photocells on the suction traps were disabled

Infusions:

The infusion concentration and incubation time differed among the experiments. In order to attract species such as Cx. tarsalis that prefers oviposition sites containing less organic enrichment than does Cx. quiquefasciatus, the organic infusions used in most of the experiments were less concentrated than recommended for the CDC gravid trap (˜4.3 g hay/L tap water: http://johnwhock.com>>_<<</products/mosquito-sandfly-traps/cdc-gravid-trap/)): 0.1 g of alfalfa rabbit pellets (Nutriphase®, Phoenix, Calif.) in 100 liters (LC) or 150 liters (LCI) of water was used to make low-concentration infusions. A high-concentration infusion used 1.0 g of alfalfa rabbit pellets in 100 liters (HC) or 150 liters (HCl) of water. Infusions using 2 g or 4 g of rabbit pellets in 150 liters of water also were tested in some experiments. Infusions were covered and fermented for 7 to 28 d in the large-volume gravid traps at the study site.

Large-Volume Fiberglass Gravid Traps:

Two series of experiments tested the performance of the large-volume fiberglass gravid traps. In the first series of three experiments, eight large-volume fiberglass gravid traps were equally spaced across a 5-m concrete slab during September-October of year 1. Two treatments were randomly assigned to the gravid traps in each experiment. The first experiment compared the number of mosquitoes collected by a single suction trap above two LCI volumes: 50 or 150 liters. The second and third experiments compared the efficacy of one or two top-mounted suction traps above the two LCI infusion volumes (50 liters vs. 150 liters).

The second series of experiments assessed the effect of infusion age on the number of mosquitoes collected by large-volume fiberglass gravid traps relative to small-volume CDC gravid traps during September-October of year 1. A randomized block design with four sites (blocks) spaced an average of 30 m apart was used to increase the coverage area of gravid mosquito lures and decrease possible interactive effects among traps. LCIs were fermented in covered fiberglass drums for 1, 2, 3, or 4 wk. Within each block, each bait-age treatment was assigned randomly to large-volume fiberglass gravid traps that were equally separated. On the first evening of the experiment, the large-volume gravid traps were uncovered and 6 liters of infusion were transferred to a paired small-volume gravid trap. A single suction trap was top-mounted on both large and small gravid traps.

Large-Volume Plastic Gravid Traps:

Gravid mosquito collections by large-volume black plastic gravid traps were compared to small-volume gravid traps during May-June of year 2. The large plastic gravid trap design was based on the fiberglass gravid trap configuration (dual suction traps+150 liters of infusion) that collected the most adult female mosquitoes and fewest egg rafts in the aforementioned experiments. Pairwise comparisons of mosquito collections by large- and small-volume gravid traps at five replicate sites were made using the randomized block experimental design described previously. LCI fermented for 10 d was used in each of X replicate tests.

The impact of infusion and trap characteristics on trapping efficacy for the three gravid trap designs was examined in experiments carried out between May and October of year 3. The first series of experiments compared mosquito collections by large-volume gravid traps using different numbers of suction traps (1, 2, or 3), infusion volumes (6, 12, 35, 100, and 150 liters) and infusion concentrations (0.1, 1, 2, and 4 g rabbit pellets/L). Because a limited number of traps was available for each experiment, a subset of the total treatment combinations was examined in each test. The three gravid trap designs were compared simultaneously, run in pairwise comparisons, or run individually to determine interactive effects among adjacent designs and/or replicate sites. Infusions were aged an average of 9 d. When both large gravid trap designs were deployed simultaneously, an equal volume of infusion (3 liters) was transferred from each large trap design into an adjacent small-volume gravid trap.

The second series of experiments examined how the physical presence and orientation of suction traps altered mosquito responses to container designs during September and October of year 3. Egg raft abundance in gravid traps with functioning suction traps was compared to gravid traps without suction traps or with suction traps that were present but turned off. Mosquito collections by the large plastic gravid traps that had been modified for side-mounted suction traps were compared to gravid traps with the standard top-mounted suction traps in a second group of experiments. Standard infusion-bait volumes were used for top-mounted small (6 liters), large plastic (100 liters), and large fiberglass (150 liters) gravid traps. Thirty-five liters of infusion were used in the large plastic gravid traps with side-mounted suction traps to homogenize trap-to-infusion surface distance. HCl and HC fermented for 9 d was used in these experiments.

Trapping sites (blocks) for the year 2 and year 3 experiments were separated by an average of 15 m. The different gravid traps were placed in a circle on the aforementioned concrete slab and at three sites northwest of nursery wetlands containing S. maritimus.

Sample Processing:

Adult mosquitoes collected by gravid traps were transported to the laboratory and frozen at −20° C. Specimens were sorted on a chill table by gender and reproductive state (gravid, blood-fed, non-gravid, unknown), and to species. Females containing a blood-meal and visible eggs were lumped in a single ‘gravid’ category in year 2 but were placed into two distinct categories in year 3. Low temperature preservation was maintained throughout sample processing and adult female mosquitoes were pooled by species for arbovirus testing in a separate study. Egg rafts, when present, were counted and removed on the morning of trap net collection.

Statistical Analysis:

Gravid trap data were pooled across traps when multiple suction traps were present on, or in, a gravid trap and across dates for a particular replicate trap when gravid mosquitoes were collected across multiple nights during a particular experiment. Data that met the assumptions of parametric statistical analyses were log₁₀(x+1) transformed and the significance of differences in gravid mosquito collections among traps designs was analyzed by Analysis of Variance (ANOVA). A post-hoc Tukey's HSD test was carried out if the ANOVA was significant (P<0.05). Data that did not meet the assumptions of ANOVA were analyzed using a non-parametric Kruskal-Wallis ANOVA (more than two variables) or Mann-Whitney U test (two variables). Experiments comparing infusion fermentations and seasonal variation in mosquito collections during year 2 required separation of sample dates in the statistical analysis; a repeated-measures Multivariate ANOVA (MANOVA) was carried out. Date effects were tested using Pillai's trace statistic (SYSTAT version 9.0, SPSS Inc., Chicago, Ill.).

Large-Volume Fiberglass Gravid Traps:

The numbers of gravid mosquitoes collected by large-volume fiberglass gravid traps averaged three females per trap night during autumn of year 1 and were the lowest of all studies (see FIG. 3). Despite low numbers of mosquitoes in collections, large-volume fiberglass gravid traps collected significantly more mosquitoes than did small-volume gravid traps (LCI: total Culex: F_{1,59}=40.41, P<0.001; Cx. quinquefasciatus: U=705.5, P<0.001) and collected Cx. tarsalis whereas the small-volume gravid traps failed to do so. Very few adult female mosquitoes (<0.1 individuals per trap night) were collected and egg rafts were not observed in small-volume gravid traps.

The number of mosquitoes collected by large-volume fiberglass gravid traps was affected by infusion volume but not by the number of suction traps per gravid tap (1 or 2) or by infusion age (LCI fermented for 1, 2, 3 or 4 wk). Large-volume gravid traps with 150 liters of infusion collected three-fold more adult Cx. quinquefasciatus females (U=20.00, P<0.05) and five-fold fewer Culex spp. egg rafts than did fiberglass gravid traps with 50 liters of infusion (FIG. 3; U=14.0, P<0.05). The number of suction traps per gravid trap did not significantly alter the number of female mosquitoes collected per gravid trap (Mann-Whitney U-tests, P>0.65); however, the number of egg rafts in gravid traps with one suction trap was five-fold greater compared to fiberglass gravid traps with two suction traps (U=48.0, P<0.05). Infusion age did not significantly influence adult mosquito or egg raft collections (infusion age: F_{3,59}<0.03, P>0.8; trap type×infusion age: F_{3,59}<0.1, P>0.98).

Large-Volume Plastic Gravid Traps:

Mosquitoes were at intermediate abundance during spring of year 2 compared to other sample years and large-volume gravid traps collected approximately an order of magnitude more mosquitoes than did small-volume gravid traps using LC as the oviposition attractant (see FIG. 3; F_{1,8}=97.34, P<0.001). The large-volume, dual-suction trap design collected at least an order-of-magnitude more Cx. quinquefasciatus (F_{1,8}=111.9, P<0.001) and Cx. tarsalis (U=293.5, P=0.002) females than did the small-volume, single suction trap design. Large-volume gravid traps >5 m from the nursery wetlands collected nearly 6-fold more Cx. tarsalis compared to replicates adjacent to the wetlands (P=0.009).

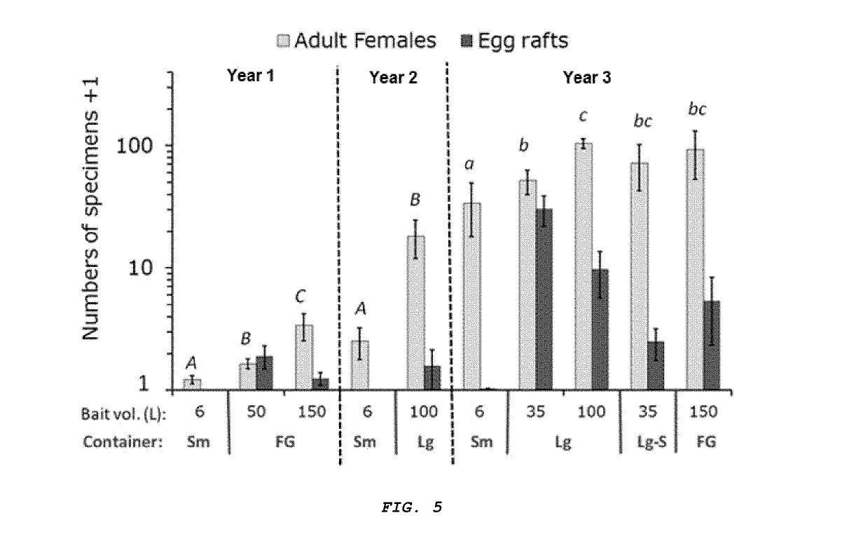

Culex quinquefasciatus was most abundant in gravid trap collections (86% of total) followed by Cx. tarsalis (7%) and Cx. stigmatosoma (4%) in experiments during year 2. About 79% of female mosquitoes were gravid (included blood-fed specimens), 15% were non-gravid, and 6% were of unknown reproductive state. The percentage of the female mosquitoes that was gravid did not differ by mosquito species, gravid trap design, within site locations, or sample date (see FIG. 5; P>0.10).

Mosquito abundance during year 3 was the highest of all years in our study, averaging 70 adult females per large-volume gravid trap per sample night using HC as the oviposition attractant. Large-volume gravid traps collected four-fold greater numbers of gravid mosquitoes compared to small-volume gravid traps (see FIG. 3); however, this relative difference in collections between trap types varied by sample season, mosquito species, and experimental modifications.

During spring (see FIG. 3), the large-volume plastic gravid trap with dual-suction traps and an infusion (LC) volume of 100 L collected at least eight-fold more adult females of the three predominant Culex species compared to the small-volume gravid traps (F_{1,18}=35.21, P<0.001). The difference in the number of Cx. tarsalis collected between the two gravid traps was even more striking (56-fold; U=83.00, P<0.005). As the year progressed, the large-volume gravid traps with dual suction traps collected 2- to 3.5-fold more Cx. quinquefasciatus (summer: F_{1,11}=6.03, P<0.035; autumn: U=80.0, P=0.013) and Cx. stigmatosoma (autumn: U=80.5, P=0.011) compared to the small-volume CDC traps. Culex tarsalis abundance did not differ between trap designs during summer and autumn (Mann-Whitney U tests, P>0.30).

Egg rafts were collected from large-volume gravid traps in all trials. Egg rafts were present in the small-volume gravid traps only during spring trials, but were 40-fold fewer than in the large-volume gravid traps (U=89.0, P<0.001).

The total number of female Culex collected per gravid trap was not influenced by the number of suction traps per gravid trap (1 vs. 2 suction traps: U=24.0, P>0.6); although the gravid traps with a single suction trap collected three-fold more egg rafts than the dual suction trap design (U=56.0, P<0.001). Adult female numbers in traps above high concentration bait (2 g/liter) were two- to four-fold more abundant than in traps above low concentration bait (0.1 g/liter) and this differential was significant for Cx. quinquefasciatus and Cx. stigmatosoma (Mann-Whitney U tests, P<0.01). Egg raft numbers were not related to infusion concentration (P=0.665). Large-volume and small-volume traps with single suction traps placed over 6 liters of infusion trapped similar adult numbers (F_{1,17}=1.29, P>0.27), even though egg rafts were abundant in the large-volume gravid trap and were absent in the small-volume gravid trap (U=90.0, P<0.001).

During autumn of year 3, the large-volume plastic gravid trap with a top-mounted suction trap (100 liters of infusion) was the most effective mosquito collector of five gravid trap designs tested (all top-mounted suction traps: large-volume plastic trap with 12 or 35 liters of infusion, large-volume fiberglass traps with 150 liters of infusion, CDC gravid traps) and averaged two- to six-fold more adult female mosquitoes than the small-volume gravid traps (F_{4,55}=21.94, P<0.001). Significantly greater numbers of each of the three Culex species were collected by the large-volume traps as compared to the small-volume gravid trap (Cx. quinquefasciatus: F_{4,55}=23.20, P<0.001; Cx. tarsalis: H₄=12.8, P=0.012; Cx. stigmatosoma: H₄=25.7, P<0.001). Egg raft abundance in large-volume gravid traps was overall higher than in small-volume gravid traps. Large-volume plastic gravid traps with 35 liters of infusion contained four-fold more egg rafts compared to the large-volume gravid trap design with the next highest number of egg rafts (H₄=32.67, P<0.01).

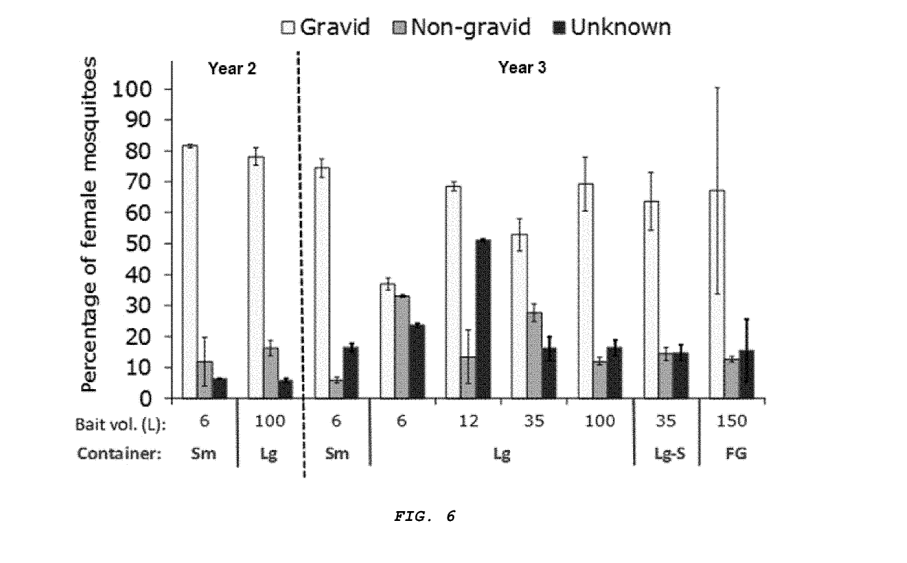

When suction traps were removed, large-volume plastic gravid traps containing 35 liters of infusion also collected the most egg rafts (P<0.05; see FIG. 6); however, gravid traps with non-operational suction traps (top-mounted) over 35 liters of infusion collected similar numbers of egg rafts compared to gravid traps holding 100 liters of infusion (Tukey's HSD, P=1.000). Non-operational side-mounted suction traps did not appear to significantly alter oviposition (data not shown).

In experiments during October-November of year 3, side-mounted suction traps above 35 liters of infusion and top-mounted traps above 100 liters of infusion captured similar quantities of adult mosquitoes (number in traps with side-mounted suction traps/number of traps with top-mounted suction traps˜1; see FIG. 4). The numbers of total Culex females, Cx. quinquefasciatus and Cx. stigmatosoma in both large-volume trap designs exceeded the small-volume traps by more than 7-fold (total Culex: F_{2,15}=28.94, P<0.001; Cx. quinquefasciatus: F_{2,15}=30.91, P<0.001; Cx. stigmatosoma: H₂=12.94, P<0.01); although, the abundance of Cx. tarsalis did not differ statistically among the three trap designs (H₂=2.38, P>0.30). The number of side-mounted suction traps (1, 2, or 4) per container did not affect the numbers of adult mosquitoes or egg raft collected (U tests, P>0.13). Culex quinquefasciatus was the predominant species (78% of total), with lesser abundance of Cx. stigmatosoma (9%), Cx. tarsalis (7%), and Culiseta spp. [2%: Cs. inornata (Williston) and Cs. incidens (Thomson)] during year 3.

Side-mounted suction traps reduced the number of egg rafts in the gravid traps by more than half (H₂=10.88, P=0.004) compared to the top-mounted suction traps on the large-volume gravid trap. Gravid traps with >2 suction traps were nearly devoid of egg rafts while gravid traps with one suction trap contained an average of two egg rafts per night. Egg rafts were absent in the small-volume gravid traps.

Side-mounted suction traps collected twice as many adult males (data not shown) compared to the trap design with top-mounted suction traps (ANOVA: F_{2,78}=93.76, P<0.001; Tukey HSD: P=0.026). Males were rare in small-volume gravid traps.

The reproductive profile of trapped female mosquitoes was 66% gravid (56% eggs visible+10% with recent blood-meal), 14% non-gravid, and 18% of unknown reproductive status. In general, small- and large-volume (>6 liters of infusion) gravid traps collected similar proportions of gravid and blood-fed Culex mosquitoes (see FIG. 5) and the dominant species, Cx. quinquefasciatus (Mann-Whitney U tests, P>0.40); however, the proportions of gravid+bloodfed Cx. stigmatosoma and Cx. tarsalis in collections from the large-volume gravid traps were between two- and four-fold higher compared to small-volume gravid traps (Mann-Whitney U tests, P<0.02). Interestingly, the proportions of gravid and blood-fed Cx. quinquefasciatus females collected by large-volume gravid traps declined markedly when the infusion volume was 6 liters (see FIG. 5; 40% vs. 73%; Mann-Whitney U tests, P<0.01); but, the proportions of gravid and blood-fed Cx. stigmatosoma and Cx. tarsalis were similar (Mann-Whitney U tests, P>0.50) in the two trap types when infusion volume was 6 liters. Regardless of infusion volume, the numbers of non-gravid Culex mosquitoes, as well as each of the three Culex species, were two- to three-times higher in large-volume gravid traps compared to the small-volume traps (Mann-Whitney U tests, P<0.02).

The number and position of suction traps affected the distribution of Culex females among the reproductive status categories in gravid trap collections. The large-volume gravid trap with a 100-liter infusion and a single top-mounted suction trap collected proportionally fewer numbers of gravid Cx. quinquefasciatus and a greater abundance of non-gravid mosquitoes compared to the same trap with two suction traps (Mann-Whitney U tests, P<0.03). The opposite trend was found for large-volume gravid traps with 35-liter infusions and side-mounted suction traps. Single side-mounted suction traps collected higher numbers of gravid Cx. quinquefasciatus and lower numbers of non-gravid mosquitoes than did traps with two side-mounted suction traps (Mann-Whitney U, P<0.05). The proportions of mosquitoes in the categories of reproductive status did not differ when either one or two suction traps were used on small-volume gravid traps (Mann-Whitney U, P>0.40). Infusion concentration was not associated with proportional differences in gravid and non-gravid mosquitoes in large-volume gravid traps with top-mounted suction traps (Mann-Whitney U, P>0.10).

A number of embodiments of the invention have been described. Nevertheless, it will be understood that various modifications may be made without departing from the spirit and scope of the invention. Accordingly, other embodiments are within the scope of the following claims.

What is claimed is:

1. A large volume gravid trap (LV-gravid trap) comprising:
a container capable of holding at least 25 liters of liquid;
one or more suction vacuum traps;
wherein the one or more suction vacuum traps are either:
(1) inserted through an opening of the side of container so that the lower portion of the suction vacuum trap projects into the inside of the container; or
(2) attached to the top of the container by use of an attachment means or by use of supports and suction trap holders.

2. The LV-gravid trap of claim 1, wherein the one or more suction traps are selected from CDC light gravid suction traps, Frommer Updraft gravid suction traps, and Reiter Cummings traps.

3. The LV-gravid trap of claim 1, wherein the one or more suction traps are CDC light gravid suction traps.

4. The LV-gravid trap of claim 1, wherein the container is capable of holding from 25 to 120 liters of liquid.

5. The LV-gravid trap of claim 1, wherein the container is a 40- to 60-gallon plastic drum.

6. The LV-gravid trap of claim 1, wherein the container is black, dark brown, or dark grey in color.

7. The LV-gravid trap of claim 1, wherein the container comprises an opening at the base of the container to allow for drainage of liquid from the container, wherein the opening may be plugged or closed to prevent unwanted drainage of the liquid from the container.

8. The LV-gravid trap of claim 1, wherein the one or more suction traps are inserted at an angle from 40° to 70° through an opening of the side of container so that the lower portion of the suction vacuum trap projects into the inside of the container.

9. The LV-gravid trap of claim 8, wherein the suction trap is inserted at a 60° angle through the opening of the side of the container, and wherein the opening is located about halfway down the side of the container.

10. The LV-gravid trap of claim 1, wherein LV-gravid comprises supports for supporting top mounted suction traps, wherein the supports are of a sufficient length to overlay or be attached to two opposing sides of the container.

11. The LV-gravid trap of claim 10, wherein the supports overlay two opposing sides of the container and further comprise notches or grooves that are dimensioned so that the top surface of the opposing sides of the container can slideably fit into the notches or grooves.

12. The LV-gravid trap of claim 11, wherein the notches or grooves are curved so as to fit the top surface of the opposing sides of a cylindrical container.

13. The LV-gravid trap of claim 1, wherein the LV-gravid trap comprises suction trap holders for top mounted suction traps, wherein the suction trap holders fit around the lower portion of the one or more suction traps and are capable of being joined together using a fastening means.

14. The LV-gravid trap of claim 13, wherein the suction trap holders comprise holes that can accommodate bolts, wherein the bolts are used to join the suction trap holders together.

15. The LV-gravid trap of claim 1, wherein the container comprises at least 35 liters of an infusion comprising fermented plant matter.

16. The LV-gravid trap of claim 13, wherein the container comprises from 35 liters to 100 liters of infusion comprising fermented plant matter.
